(19) United States
(12) Patent Application Publication
(10) Pub. No.: US 2004/0239772 A1
(43) Pub. Date: Dec. 2, 2004

(54) Charger with communication function

(76) Inventors: Toshiaki Onishi, Kanagawa (JP); Akira Ichikawa, Chiba (JP); Katsuhiko Otomoto, Tokyo (JP)

Correspondence Address: Pitney Hardin Kipp & Szuch, 685 Third Avenue, New York, NY, 10017-4024, US

(21) Appl. No.: 10/479,097

(22) PCT Filed: Jul. 10, 2002
(86) PCT No.: PCT/JP02/06993

(30) Foreign Application Priority Data
Aug. 6, 2001 (JP) 2001238525

(51) Int. Cl. H04N 5/225

(52) U.S. Cl. 348/211.2; 348/373

(57) ABSTRACT

A digital camera data transmission stand capable of acquiring image data from a digital camera and transmitting the acquired data is proposed. Moreover, a digital camera data transmission stand, further having a function of charging the battery of a digital camera, is proposed. Moreover, the digital camera data transmission stand can be fixed on the stand regardless of the size of the digital camera. Regardless of the type of digital camera, image data can be transmitted, and the battery can be charged.

### BACKGROUND OF THE INVENTION

1. Field of the Invention

The present invention relates to a stand for transmitting data from a digital camera in order to store image data stored in a digital camera in an external device by using communication, and a stand for charging a battery of an electronic device such as a digital camera.

2. Description for the Related Art

Conventionally, image data taken by a digital camera is stored in a semiconductor memory such as an IC card or a movable storage medium such as a magnetic disk built into the digital camera. Additionally, these IC cards and magnetic disks are removable from the digital camera. Therefore, in cases where IC cards and magnetic disks reach capacity, thereby making it impossible to store additional image data, it is required to replace these IC cards and magnetic disks with spares.

Moreover, digital cameras have a rechargeable battery or a dry-cell battery etc. built therein. When they become exhausted, the user is without an energy source. The user must extract the exhausted battery and replace it with a charged battery. Secondly, the user must extract the exhausted dry-cell battery and replace it with a charged dry-cell battery.

### SUMMARY OF THE INVENTION

Typically, it is required to carry a spare IC card or magnetic disk, which is empty, when taking pictures because it is required to replace a semiconductor memory such as an IC card or a magnetic disk to store image data taken by the digital camera when they become full of data. However, there is a risk of forgetting to carry them. This also holds true for batteries. Meanwhile, it is difficult to buy these IC cards, magnetic disks, and batteries when outside because they are relatively expensive. Similarly, it is not easy to locate stores that carry all types of IC cards, magnetic disks and batteries etc. compatible with each type of digital camera.

According to the present invention, the digital camera data transmission stand, acquiring image data from a digital camera and transmitting acquired data, is proposed in order to solve the above deficiency. Moreover, the digital camera data transmission stand further performs a function of charging a battery of the digital camera. Furthermore, this digital camera data transmission stand engages a camera regardless of the size of the camera. Moreover, it is able to transmit image data to different types of cameras and charge the batteries thereof.

### BRIEF DESCRIPTION OF THE DRAWINGS

FIG. 1 is a schematic view of the present invention,

FIG. 2 is a functional block diagram of the first embodiment of the present invention,

FIG. 3 is a functional block diagram of the first embodiment of the present invention,

FIG. 4 is a functional block diagram of the first embodiment of the present invention,

FIG. 5 is a functional block diagram of the second embodiment of the present invention,

FIG. 6 is a functional block diagram of the second embodiment of the present invention,

FIG. 7 is a side view (a) and a perspective view (b) of the third embodiment of the present invention,

FIG. 8 is a side view (a) and a perspective view of the coiled spring (b) of the fourth embodiment of the present invention,

FIG. 9 is a partial section side view (a) and a perspective view of the coiled spring (b) of the fifth embodiment of the present invention,

FIG. 10 is a schematic view of the transformer mechanism of the fifth embodiment of the present invention,

FIG. 11 is a schematic view of the sixth embodiment of the present invention,

FIG. 12 is a perspective view of the seventh embodiment of the present invention,

FIG. 13 is a perspective view of the seventh embodiment of the present invention,

FIG. 14 is a partial side view illustrating the charging process in a non-contact way of the seventh embodiment of the present invention,

FIG. 15 is a side view of the seventh embodiment of the present invention,

FIG. 16 is a perspective view of the seventh embodiment of the present invention.

### DETAILED DESCRIPTION OF THE PREFERRED EMBODIMENT

The first embodiment of the present invention will be described.

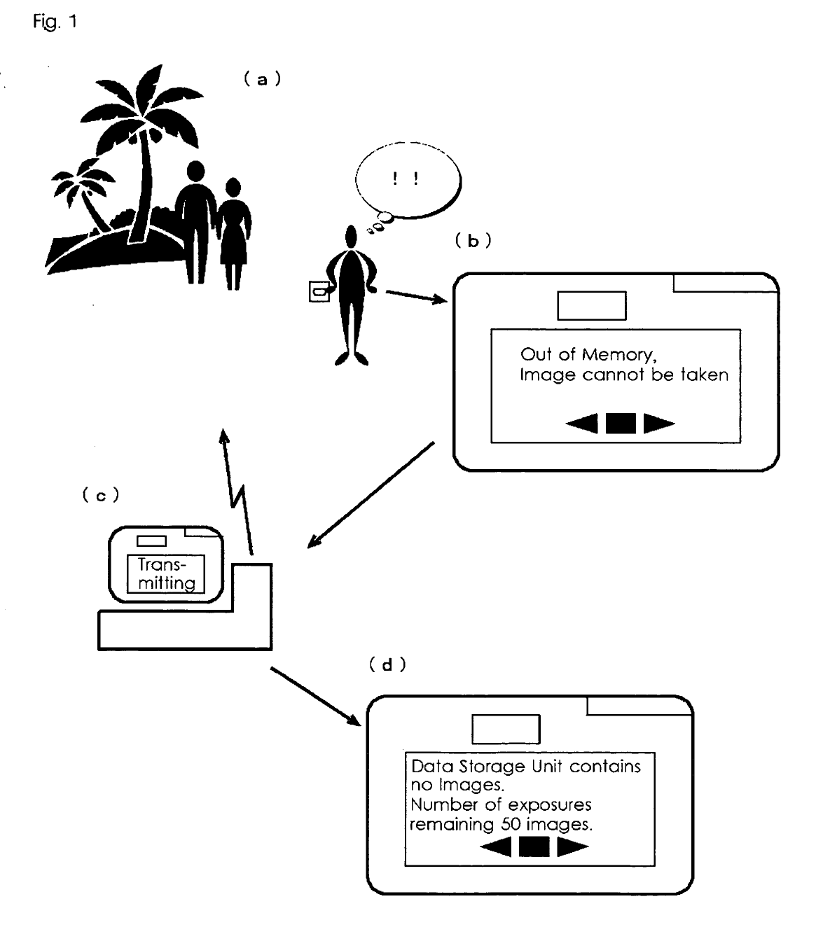

The first embodiment is a digital camera data transmission stand that is the basic embodiment of the present invention. FIG. 1 illustrates a concept of use of the present invention. This illustrates a scene in which a person tries to take a picture with a digital camera outside (a), a liquid-crystal-display warns, “Out of memory, image cannot be taken” (b). Transmitted data stored in the data storage unit of a digital camera to, for example, a hard disk drive of a home personal computer by using the digital camera data transmission stand of the present embodiment (c), then the data storage unit of the digital camera becomes empty, thereby enabling it to take pictures (d). Therefore, it is not necessary to carry a spare IC card or magnetic disk for a digital camera. So, it is easy to clear data from the data storage unit by using this digital camera data transmission stand.

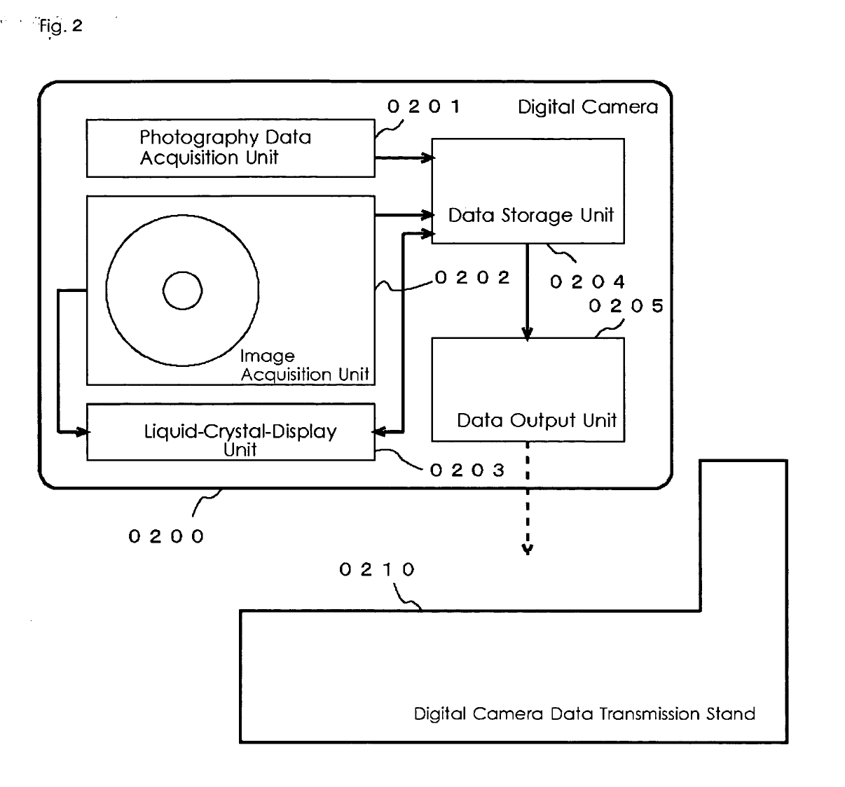

FIG. 2 is a functional block diagram of digital camera 0200, utilizing the invention of the present embodiment. Herein, the digital camera 0200 may correspond to a camera that is able to take not only still pictures but also moving pictures. Moreover, it may correspond to a hybrid electronic device comprising multiple functions such as a digital camera, a mobile phone, a copy machine, a printer, a personal computer, a PDA, a wrist watch, and a telescope etc.

As shown in FIG. 2, this digital camera 0200 comprises the image acquisition unit 0202 including a lens and image pickup device, a data storage unit 0204 for storing acquired image data, a data output unit 0205 outputting data stored by the data storage unit 0204. Moreover, it comprises a liquid-crystal-display 0203 for displaying image data received by the image acquisition unit 0202 on the digital camera 0200 itself, and the photography data acquisition unit 0201 receiving photography data such as date and so on. This data output unit 0205 may correspond to cases that can output data externally via either wired communication or wireless communication.

Wireless communication can comprise, for example, data output by using a transformer such as a non-contact charging system of a mobile phone and a mechanism of transmitting a signal, received by a magnetic head arranged on the drum of a video cassette recorder, to the image processing circuit thereof.

The “data storage unit” corresponds to a unit for storing image data received by the image acquisition unit and photography data received by the photography data acquisition unit etc. Various types of media such as semiconductor memory, magnetic memory, DVD, FD, and CDRW etc, are available. These may be used for either temporary storage or short-term.

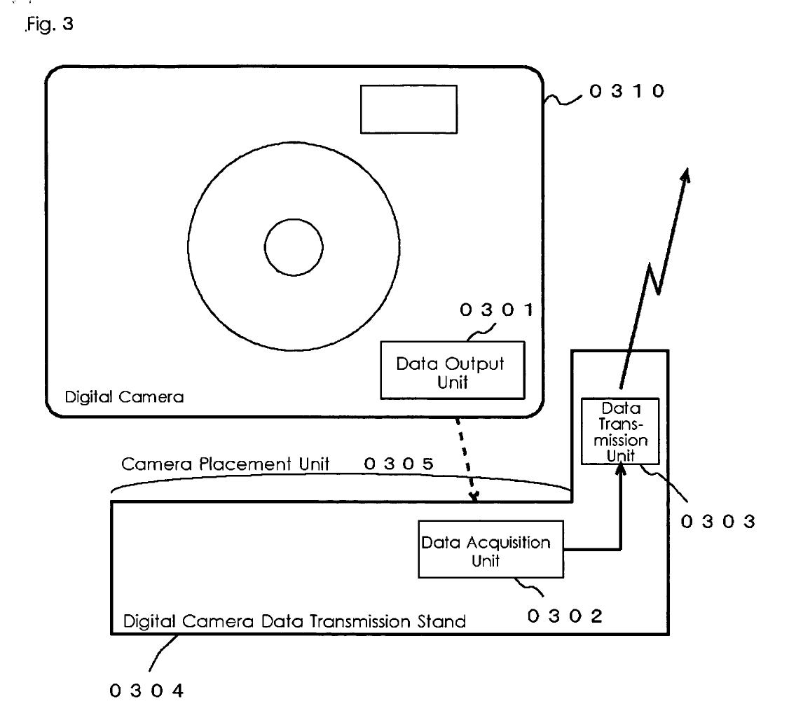

FIG. 3 is a functional block diagram of the digital camera data transmission stand of the first embodiment of the present invention. As shown in this FIG. 3, this digital camera data transmission stand 0304 comprises the camera placement unit 0305, the data acquisition unit 0302, and the data transmission unit 0303. The “camera placement unit” corresponds to a unit on which the digital camera 0310 can be placed. “Placement” corresponds to the placement of the digital camera 0310. However, in the present invention, it broadly corresponds to all of the units for placing the digital camera 0310 on the digital camera data transmission stand 0304. Therefore, the spatial relationship wherein the digital camera is placed above the placement unit is not critical. The spatial relationship, wherein the digital camera and the placement unit are placed side by side, or wherein the placement unit is placed above the digital camera, may be permitted. Moreover, the unit to be placed may be any surface or may be over multiple surfaces of the digital camera.

The “data acquisition unit” receives data from the data output unit of the digital camera placed on the placement unit. Data may be received by connecting the data output unit to the data acquisition unit of the digital camera by either wired or wireless connections. The case of receiving by a wireless connection corresponds to a case of electrically transmitting data by using what is called a transformer mechanism, by using an optical signal, by using sound, or vibration etc.

The “data transmission unit” transmits the data received by the acquisition unit. The transmission unit may transmit data either directly or via another transmission device, for example, a mobile phone. Therefore, transmission of data may be done by using either a public line of a mobile phone or an internet connection. The transmission destination may be, for example, a data storage center storing business data, a home personal computer, a hard disk drive of a personal computer. Moreover, it may be a print center printing image data. Either way may be permitted as long as the image data taken by the digital camera is transmitted safely without corruption of data.

The data transmission destination need not be one, and may be multiple. Therefore, it may be not only transmitted to a specific destination in communication, but also transmission to unspecific multiple destinations such as a broadcast. Note that the content of data to be transmitted may be still pictures, animation, photography data (date, temperature, weather conditions, user attribute data), and data including signals such as sound and characters etc.

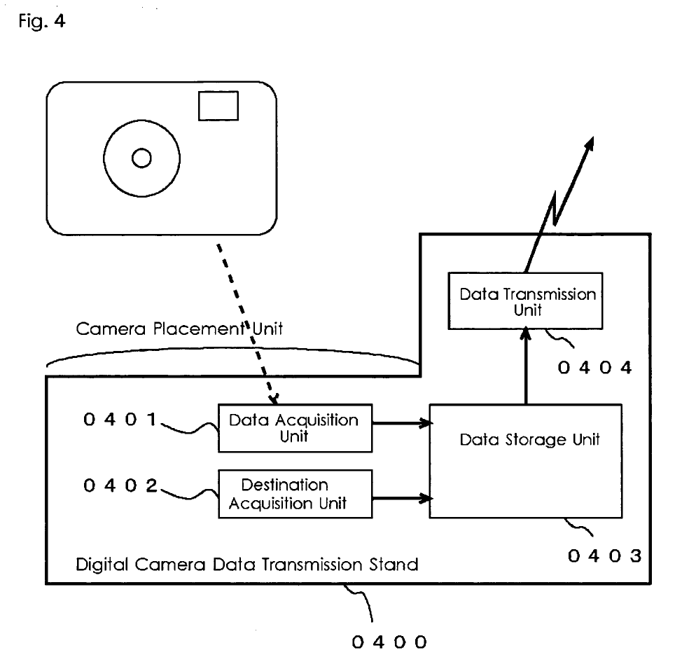

FIG. 4 is a functional block diagram of another example of the digital camera data transmission stand 0400 of the present embodiment. As shown in FIG. 4, the digital camera data transmission stand 0400 comprises the data acquisition unit 0401, the data transmission unit 0404, the transmission destination acquisition unit 0402, and the data storage unit 0403. The “transmission destination acquisition unit” receives the address of the transmission destination of the digital camera data etc. The address of the transmission destination corresponds to, for example, the IP address of the internet, a home PC, a data storage center, and telephone number for connecting to the print center. Data to be received may be either internal data stored by the digital camera data transmission unit or external data received by communication or manually.

The “data storage unit” temporarily stores data received by the data acquisition unit from the digital camera such as image data, photography data, and sound data etc. The storage capacity of the digital storage unit is typically greater than that of the storage unit of the digital camera. Because it is intended to transmit stored data only when the data storage unit reaches the capacity of data acquired from the digital camera, not to transmit from the digital camera data transmission stand even when the data storage unit of the digital camera reaches capacity. Therefore, it is possible to reduce communication costs.

Next, the second embodiment will be described.

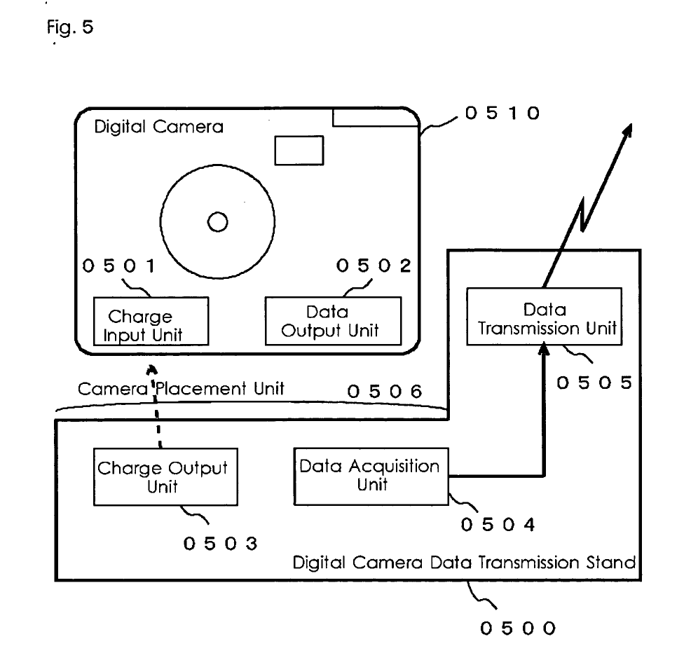

The second embodiment is the digital camera data transmission stand, further comprising the charger output unit based on the invention of the first embodiment. FIG. 5 is a functional block diagram of this embodiment. As shown in this FIG. 5, the digital camera comprises the data output unit 0502, outputting data, and the charge input unit 0501, charging the battery for operating the digital camera. Moreover, as in the first embodiment, this digital camera transmission stand 0500 comprises the camera placement unit 0506, the data acquisition unit 0504, and the data transmission unit 0505. This embodiment is characterized in that the digital camera, comprising the charge input unit 0501, charging the battery, placed on the camera placement unit 0506, further comprising the charge output unit 0503 charging the battery via the charge input unit 0501.

Another deficiency of movable electronic devices, such as digital cameras, is that an extended operation exhausts the battery, so that replacement of the battery is required when no other energy source is available. However, carrying a spare battery can be troublesome. Moreover, in cases where there are multiple electronic devices to be carried, it is also troublesome to carry multiple batteries for each device.

According to the present embodiment, this digital camera transmission stand also comprises the charge output unit, charging the battery of the digital camera, thereby enabling not only the reception and transmission of the data but also to solve the above deficiency.

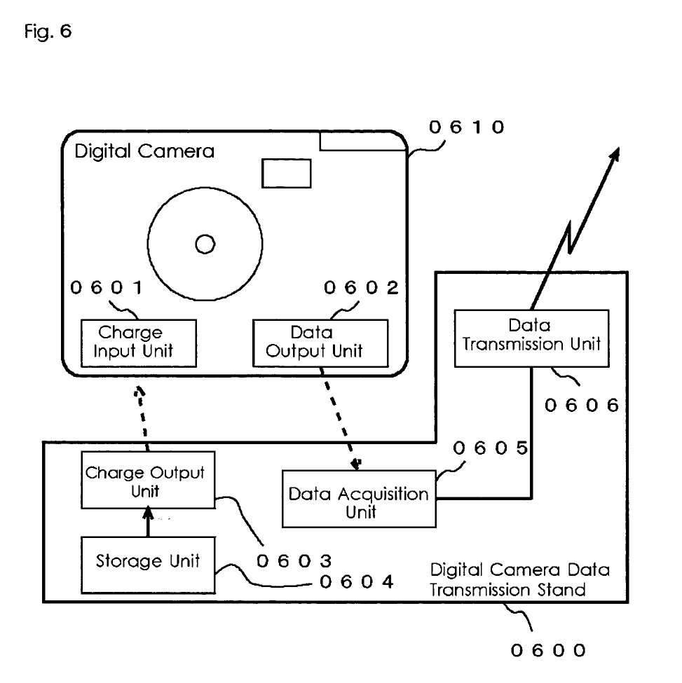

FIG. 6 is a functional block diagram of another example of the present embodiment. As shown in this FIG. 6, this digital camera data transmission stand 0600 comprises the charge output unit 0603, the storage unit 0604, the data acquisition unit 0605, and the data transmission unit 0606. Moreover, the digital camera 0610, using the digital camera data transmission stand 0600, comprises the charge input unit 0601 and the data output unit 0602. The digital camera data transmission stand 0600 includes the storage unit 0604 in addition to the charge output unit 0603. Preferably, the “storage unit”, storing electricity to be charged to the battery of the digital camera, has a higher capacity than that of the battery of the digital camera. Thereby it becomes possible to make the battery of the digital camera smaller and lighter, and makes it easy to take pictures. Moreover, this digital camera data transmission stand reduces concerns over battery depletion. This storage unit may acquire electricity from a household wall plug and store it.

Next, the third embodiment will be described.

The third embodiment is characterized in having a mechanism of engaging a digital camera based on the first and the second embodiments.

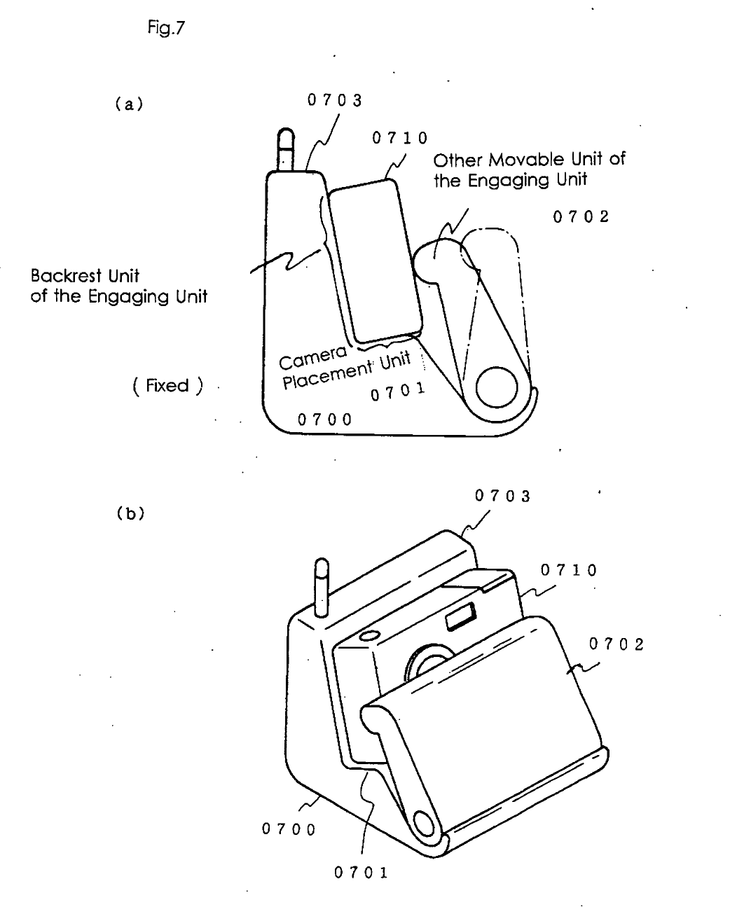

FIG. 7 is a view of an example of the digital camera data transmission stand of this embodiment. (a) is a side view, and (b) is a perspective view. As shown in this FIG. 7, the digital camera data transmission stand 0700 comprises the engaging unit 0702 and 0703 to engage the digital camera 0710 on the camera placement unit 0701. The “engaging unit” may correspond to various modes wherein it engages the digital camera by various methods, and holds it on the camera placement unit. Therefore, there may be either the case where one 0703 is fixed and the other 0704 is movable or the case where both are movable. It is an object of engaging the digital camera on the camera placement unit, firstly to receive data from the digital camera, and secondly to charge the digital camera. Therefore, various modes, which are methods of engaging to implement this object, may be adopted. Moreover, the “engaging unit” may not be independent of the “camera placement unit” and the engaging unit and camera placement unit should share at least some common elements. The part that contacts the digital camera for engaging may not necessarily be rigid and may be elastic. Moreover, various shapes of a contact part to the digital camera may be used. It may be a stick, a plate, as shown in FIG. 7, spherical, semispherical, moreover, a ribbon, or amorphous. Amorphous corresponds to, for example, gel. By using a gelatinous material, it becomes possible to hold various digital cameras according to the shape thereof.

In the digital camera data transmission stand 0700, the camera placement unit 0701 is arranged and configured in a slightly tilted position. Therefore, the digital camera placed on this camera placement unit 0701 slides, by itself, along the incline of the camera placement unit 0701, and is held by the movable unit 0702 of the engaging unit, so that the digital camera is stabilized to the camera placement unit 0701 as a result.

As shown in FIG. 7 (b), since the shape of the contact part with the digital camera 0710 is a stick, the movable unit 0702 of this engaging unit makes rectilinear contact with the digital camera 0710. The advantage of this is that the digital camera can be held from many sides, so that it is securely held. Moreover, from the aspect that the digital camera is held by the engaging unit, it makes rectilinear contact with the digital camera, which means it makes point contact with the digital camera, so that the digital camera is held with security because, viewing from the direction of pressing the digital camera by the engaging unit, it is point-contact, so that there is no energy from multiple directions.

Next, the fourth embodiment will be described.

The fourth embodiment is characterized in that the engaging unit elastically applies energy in the direction of engagement of the digital camera.

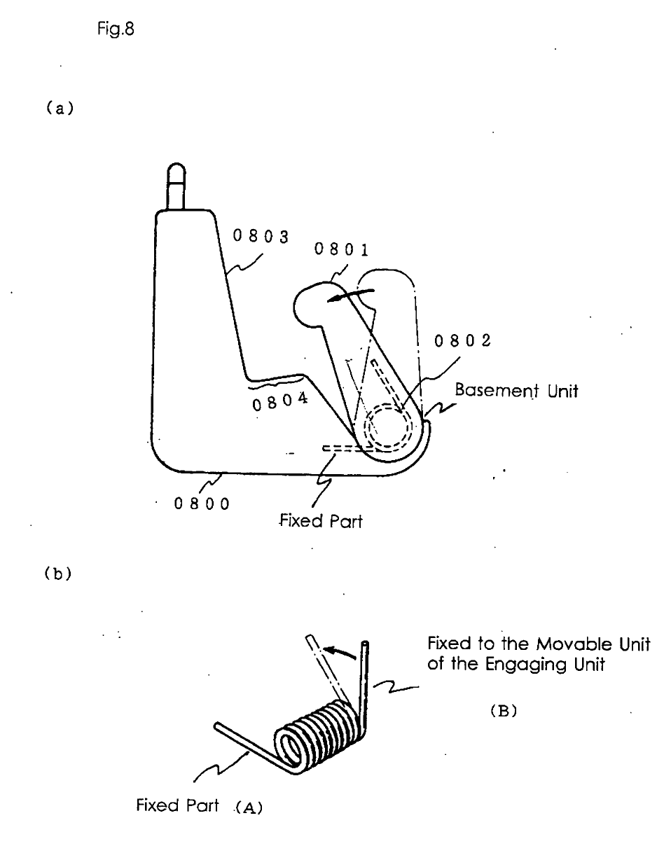

FIG. 8 shows that a part of the engaging unit 0801 of the digital camera data transmission stand 0800 described in the fourth embodiment applies energy in the direction (arrow) of engagement of the digital camera elastically by using the coil spring 0802.

As shown in FIG. 8 (a), the engaging unit 0801, which is the other movable unit of 0803, is supported pivotally at the base, thereby enabling the movable unit 0801 to move rotationally by using an axis. FIG. 8 (a) shows a perspective side view of the coil spring indicated by a dotted line. The coil spring is extracted and shown in FIG. 8 (b). As shown in this FIG. 8, one end of the coil spring (A) is fastened to the digital camera data transmission stand, and the other end (B) thereof is fastened on to the movable unit of the engaging unit. Therefore, it becomes possible for the engaging unit 0801 and 0803 to elastically hold the digital camera on the camera placement unit 0804 by the elasticity of this spring.

Note that the elasticity is implemented by the coil spring here, method of implementing elasticity is not limited to a coil spring. Various springs, for example, plate springs, spiral springs, air springs, repulsively interacting magnets, and rubber etc. may be used.

Next, the fifth embodiment will be described.

The fifth embodiment is characterized in that the engaging unit comprises a sliding method based on the digital camera data transmission stand of the third embodiment. According to the sliding method of this embodiment, the engaging unit is able to hold the digital camera by sliding, regardless of its size. Therefore, this digital camera data transmission stand becomes available as a data transmission device of not only one type of digital camera, but also various digital cameras.

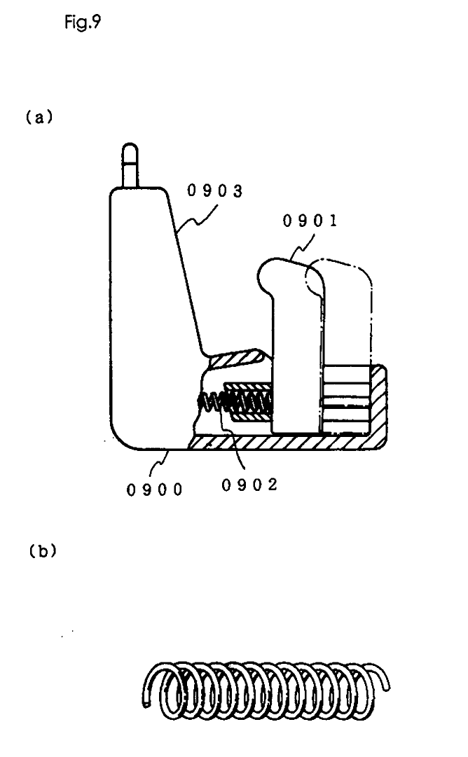

FIG. 9 (a) is a partial section view of the digital camera data transmission stand 0900 of this embodiment. As shown in this FIG. 9, the engaging unit 0901 and the movable unit 0903 slide on the digital camera data transmission stand. Then, it becomes possible to stabilize various sizes of the digital cameras by sliding. This slide applies energy elastically by the coil spring shown in FIG. 9 (b), so that it becomes possible to press the digital camera on the backrest unit that is a unit of the engaging unit.

This digital camera data transmission stand 0902 supports various sizes of digital cameras. From this point of view, it is useful to adopt a transformer for acquiring data and implementing a charge. Although, in cases where digital cameras are various sizes, it is difficult to fit the position of the data output unit of the digital camera with the position of the data acquisition unit and the digital camera data transmission stand completely. However, by using the transformer, it becomes possible to transmit the data or to charge the camera without completely fitting their respective positions. Therefore, it is beneficial to implement them in a non-contact way.

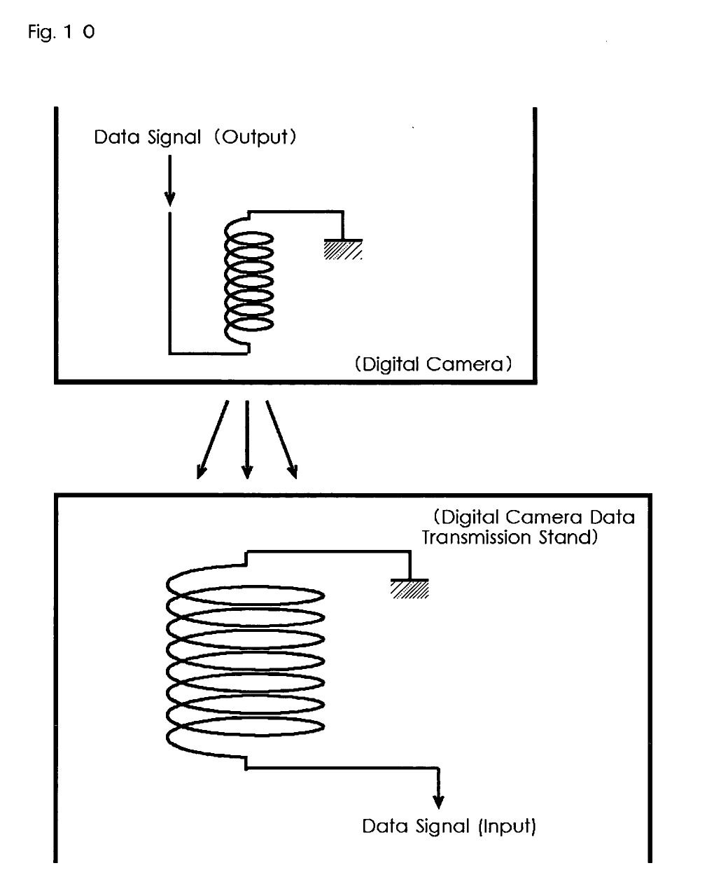

FIG. 10 is a schematic view illustrating this benefit. As shown in this FIG. 10, comparing with the coil, outputting the data of the digital camera, the coil of the digital camera data transmission stand is large, so that a fixed position of the digital camera on the camera placement unit may be irregular. Because the coil of the digital camera data transmission stand is large, magnetic flux of the signal from the digital camera falls therein.

Next, the sixth embodiment will be described.

The sixth embodiment is a charge apparatus, placing a battery and an electronic device comprising a charge input unit charging the battery, and charging the battery via the charge input unit. This charge apparatus 1100 comprises the placement unit 1106, the engaging unit 1102 and 1103, and the charge output unit 1104. The placement unit 1106 places an electronic device thereon. The engaging units 1102 and 1103 hold the electronic device 1101, to be placed on the placement unit 1106, between them. The charge output unit 1104 charges the battery via the charge input unit.

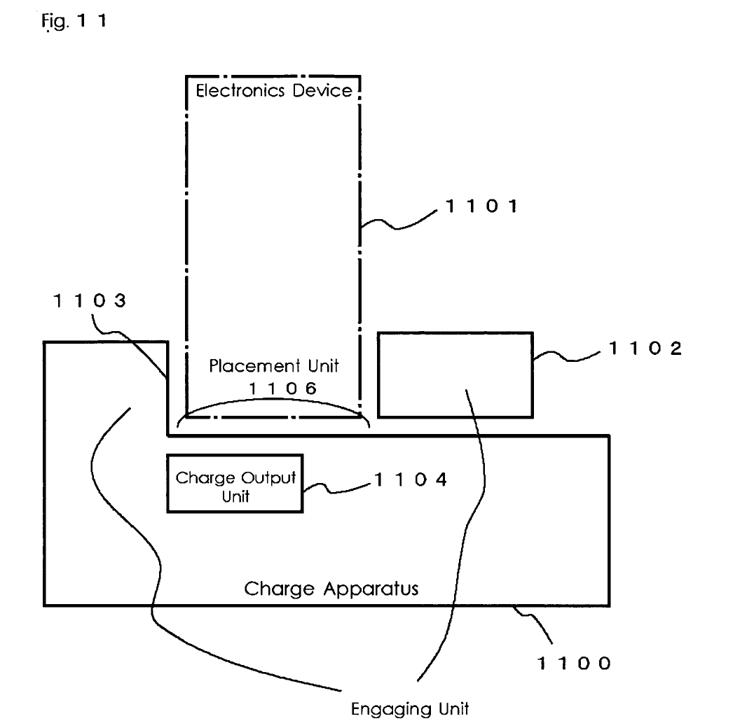

FIG. 11 is a functional block diagram of this charge apparatus. As shown in this FIG. 11, the charge apparatus 1100 places the electronic device 1101 illustrated by broken line on the placement unit 1106. Then, the charge input unit of the electronic device 1101 is charged with electricity from the charge output unit 1104. The charge output unit 1104 may output electricity, supplied from a household plug for example, to the charge input unit of the electronic device and may store electricity acquired from a household plug in the charge apparatus, after that it may output the stored electricity from the charge output unit.

Next, the seventh embodiment will be described.

The seventh embodiment is a charge apparatus characterized in that the engaging unit elastically applies energy in the direction of holding of the electronic device. The object and the method of applying energy in this embodiment is the same as described in the fourth embodiment.

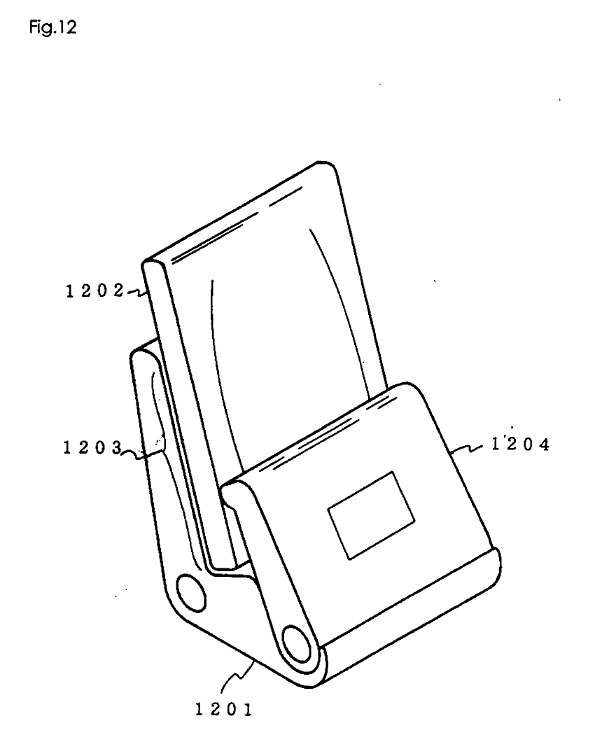

FIG. 12 is a perspective view illustrating the case wherein the electronic device 1202 is placed on the placement unit for being charged by the charge apparatus of this embodiment. The engaging units 1203 and 1204 are comprised of the backrest unit 1203 and the other movable unit 1204. Moreover, the movable unit is pivotally supported by a part of the charge apparatus 1201, and becomes able to move rotationally by using the pivot. Moreover, it applies energy elastically so that the charge unit is able to hold the electronic device by placing it on the placement unit and engaging it, according to size thereof.

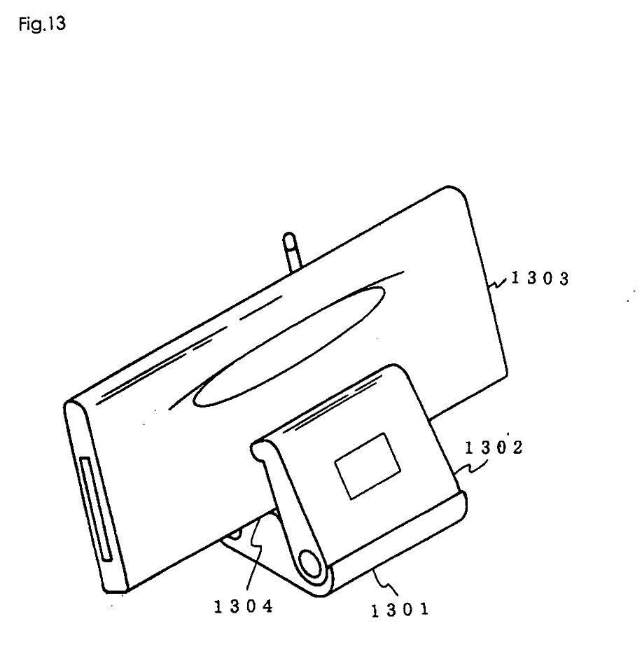

FIG. 13 shows the case wherein the electronic device 1303 of the other embodiment is placed on the charge apparatus of this embodiment. For example, in cases where the electronic device is bigger than that shown in FIG. 12, it becomes possible to hold it on the placement unit 1304 by changing the way of placement, such as horizontal. This is implemented by the engaging unit 1302, capable of holding regardless of size. Moreover, although it is not illustrated, an electronic device may be held between by slide of the engaging unit, the same as in the fifth embodiment.

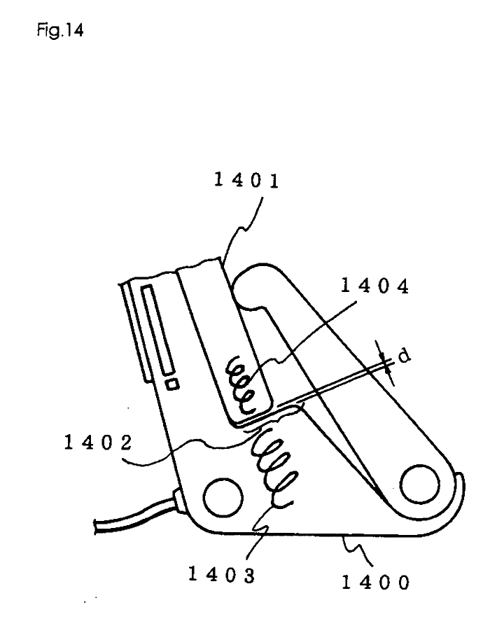

FIG. 14 is a partial view illustrating that the charge from the charge apparatus 1400 to the electronic device 1401 is done in a non-contact way. Although interspace is left between the charge apparatus 1400 and the electronic device 1401 placed on the placement unit 1402, each of them comprises the coil 1403 or 1404 of the transformer, so that it becomes possible to charge via this space.

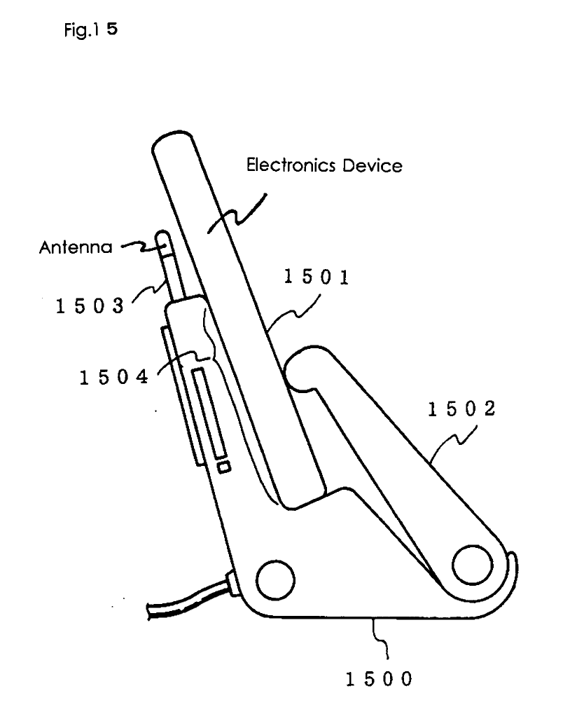

FIG. 15 is a side view illustrating that the electronic device 1501 is placed on this charge apparatus 1500. As shown in this FIG. 15, this charge apparatus 1500 holds the electronic device 1501 by the engaging units 1502 and 1504, acquires data from the electronic device 1501, and may transmit the data using the antenna 1503. The concrete configuration of this case is the same as that in the first embodiment.

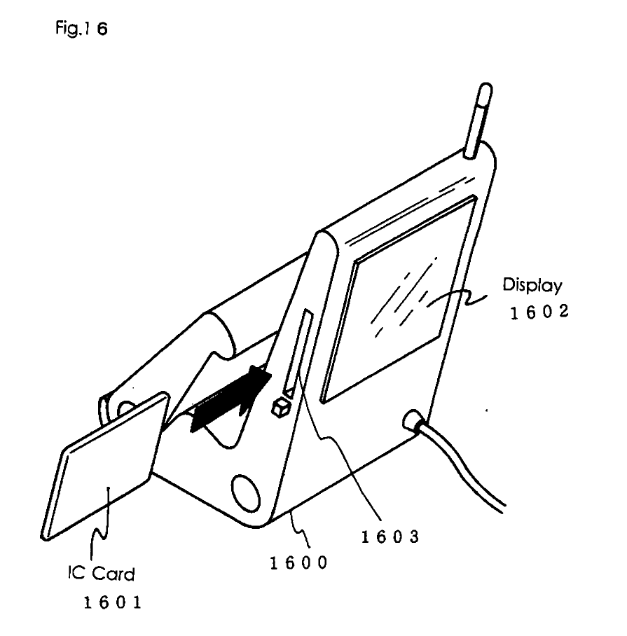

FIG. 16 illustrates that this charge apparatus 1600 comprises the IC card slot 1603. This IC card slot 1603 is used, via the IC card 1601, for charging with respect to each electronic device, reading a driver for acquiring data, and acquiring information regarding the transmission destination of data. Moreover, it is possible to read software for encrypting data to be transmitted, or to encrypt data by using the microprocessor comprised in this IC card 1601 itself. Moreover, this charge apparatus 1600 can display various types of information regarding the charge by comprising the display 1602. The various types of information regarding the charge correspond, for example, to information indicating how much a battery of an electronic device has been charged, information for confirmation of content of information to be transmitted, information indicating a transmission destination, and information indicating the connection status with the transmission destination etc.

According to various embodiments of the present invention, benefits hereinafter are implemented. Firstly, data can be transmitted by the digital data transmission stand or by the charge apparatus used for electronic devices, so that, in cases where a semiconductor memory such as an IC card, storing image data taken by a digital camera and data generated by an electronic device, and a magnetic disk reach capacity and no memory source is available, it becomes unnecessary to carry a spare IC card and a magnetic disk. Moreover, in cases where one might forget to carry a spare battery, it becomes possible to reduce the arduousness. Since many types of IC cards and magnetic disks, and batteries etc. exist with respect to each type of digital camera and there are few shops dealing with each respective type, it is difficult to purchase them when needed. However, the digital camera data transmission stand and the charge apparatus of the present invention are compatible with various sizes of digital cameras and electronic devices, so that it is sufficient to carry one digital camera data transmission stand or one charge apparatus.

1-16. (cancelled).

17. A charge apparatus, wherein the electronic device comprising the battery and the charge input unit capable of charging said battery is placed thereon and said battery is charged via said charge input unit, and data is received from said electronic device and transmitted, comprising:
a charge output unit capable of charging said battery via said charge input unit, and
an IC card slot unit into which an IC card is inserted for the purpose of acquiring information regarding the transmission destination to which said data is to be transmitted.

18. The charge apparatus as defined in claim 17 comprising the display for displaying any one or more than one of the following: information for confirming data to be transmitted, information regarding the transmission destination, and information indicating the state of connection with the transmission destination.
